(19) United States
(12) Patent Application Publication
(10) Pub. No.: US 2016/0217157 A1
(43) Pub. Date: Jul. 28, 2016

(54) RECOGNITION OF ITEMS DEPICTED IN IMAGES

(71) Applicant: eBay Inc., San Jose, CA (US)

(72) Inventors: Kevin Shih, Urbana, IL (US); Wei Di, San Jose, CA (US); Vignesh Jagadeesh, Santa Clara, CA (US); Robinson Piramuthu, Oakland, CA (US)

(21) Appl. No.: 14/973,582

(22) Filed: Dec. 17, 2015

Related U.S. Application Data
(60) Provisional application No. 62/107,095, filed on Jan. 23, 2015.

(51) Int. Cl. G06F 17/30

(52) U.S. Cl. CPC G06F 17/30256; G06F 17/30253; G06F 17/30259; G06F 17/30867

(57) ABSTRACT

Products (e.g., books) often include a significant amount of informative textual information that can be used in identifying the item. An input query image is a photo (e.g., a picture taken using a mobile phone) of a product. The photo is taken from an arbitrary angle and orientation, and includes an arbitrary background (e.g., a background with significant clutter). From the query image, the identification server retrieves the corresponding clean catalog image from a database. For example, the database may be a product database having a name of the product, image of the product, price of the product, sales history for the product, or any suitable combination thereof. The retrieval is performed by both matching the image with the images in the database and matching text retrieved from the image with the text in the database.

### PRIORITY CLAIM

The application claims priority to U.S. Provisional Patent Application No, 62/107,095, filed Jan. 23, 2015, entitled “Efficient Media Retrieval,” which is incorporated herein by reference in its entirety.

### TECHNICAL FIELD

The subject matter disclosed herein generally relates to computer systems that identify items depicted in images. Specifically, the present disclosure addresses systems and methods related to efficient retrieval of data for an item from a media database.

### BACKGROUND

An item recognition engine can have a high degree of success in recognizing items depicted in images when the query image is cooperative. Cooperative images are those taken with proper lighting, wherein the item is directly facing and properly aligned with the camera, and wherein the image depicts no objects other than the item. The item recognition engine may not be able to recognize items depicted in non-cooperative images.

### BRIEF DESCRIPTION OF THE DRAWINGS

Some embodiments are illustrated, by way of example and not limitation, in the figures of the accompanying drawings.

FIG. 1 is a network diagram illustrating a network environment suitable for identifying items depicted in images, according to some example embodiments.

FIG. 2 is a block diagram illustrating components of an identification server suitable for identifying items depicted in images, according to some example embodiments.

FIG. 3 is a block diagram illustrating components of a device suitable for capturing images of items and communicating with a server configured to identify the items depicted in the images, according to some example embodiments.

FIG. 4 illustrates reference and non-cooperative images of items, according to some example embodiments.

FIG. 5 illustrates operations of text extraction for identifying items depicted in images, according to some example embodiments.

FIG. 6 illustrates an input image depicting an item and sets of proposed matches for the item, according to some example embodiments.

FIG. 7 is a flowchart illustrating operations of a server in performing a process of identifying an item in an image, according to some example embodiments.

FIG. 8 is a flowchart illustrating operations of a server in performing a process of automatically generating a for-sale listing for an item depicted in an image, according to some example embodiments.

FIG. 9 is a flowchart illustrating operations of a server in performing a process of providing results based on an item depicted in an image, according to some example embodiments.

FIG. 10 is a block diagram illustrating an example of a software architecture that may be installed on a machine, according to some example embodiments.

FIG. 11 illustrates a diagrammatic representation of a machine in the form of a computer system within which a set of instructions may be executed for causing the machine to perform any one or more of the methodologies discussed herein, according to an example embodiment.

### DETAILED DESCRIPTION

Example methods and systems are directed to identification of items depicted in images. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Products (e.g., books or compact discs (CDs)) often include a significant amount of informative textual information that can be used in identifying the item from an image depicting the item. Portions of the product including such textual information include the front cover, back cover, and spine of a book, and the front, back, and spine of a CD, digital video disc (DVD), or Blu-Ray™ disc. Other portions of products including informative textual information are covers, packaging, and user manuals. Traditional optical character recognition (OCR) can be used when the text on the item is aligned with the edges of the image and the image quality is high. Cooperative images are those taken with proper lighting, wherein the item is directly facing and properly aligned with the camera, and wherein the image depicts no objects other than the item. Images lacking one or more of these features are termed “non-cooperative.” As an example, an image taken with poor lighting is non-cooperative. As another example, an image that includes occlusions that block one or more portions of the depiction of the item is also non-cooperative. Traditional OCR may be unsuccessful when dealing with non-cooperative images. Accordingly, the use of OCR at a sub-word level may provide some information regarding potential matches that can be supplemented by the use of direct image classification (e.g., using a deep convolutional neural network (CNN)).

In some example embodiments, a photo (e.g., a picture taken using a mobile phone) is an input query image. The photo is taken from an arbitrary angle and orientation and includes an arbitrary background (e.g., a background with significant clutter). From the query image, the identification server retrieves a corresponding clean catalog image from a database. For example, the database may be a product database having a name of the product, image of the product, price of the product, sales history for the product, or any suitable combination thereof. The retrieval is performed by both matching the image with the images in the database and matching text retrieved from the image with the text in the database.

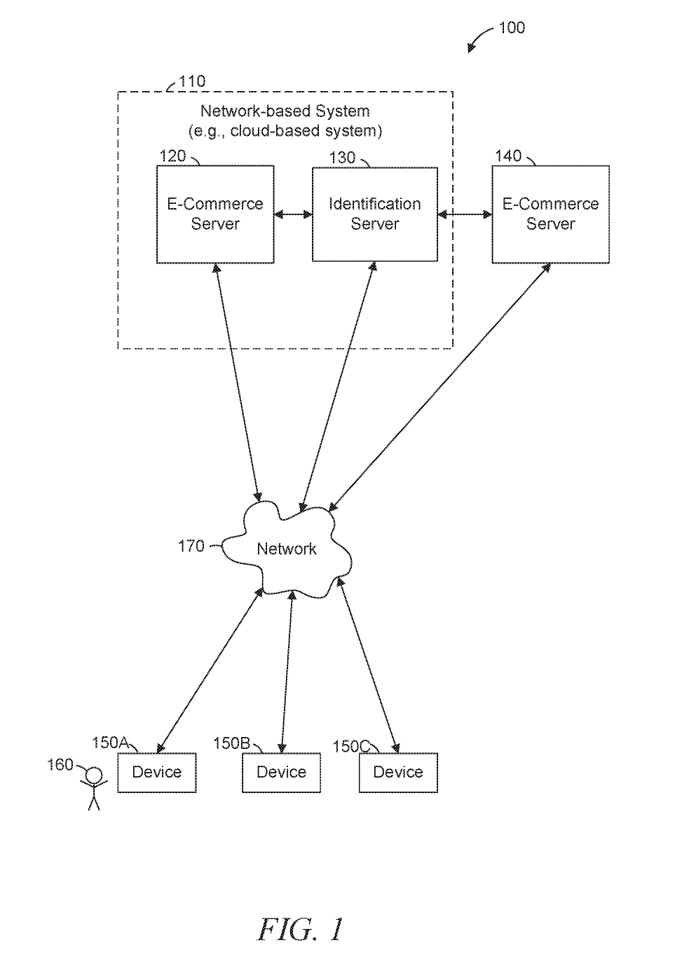

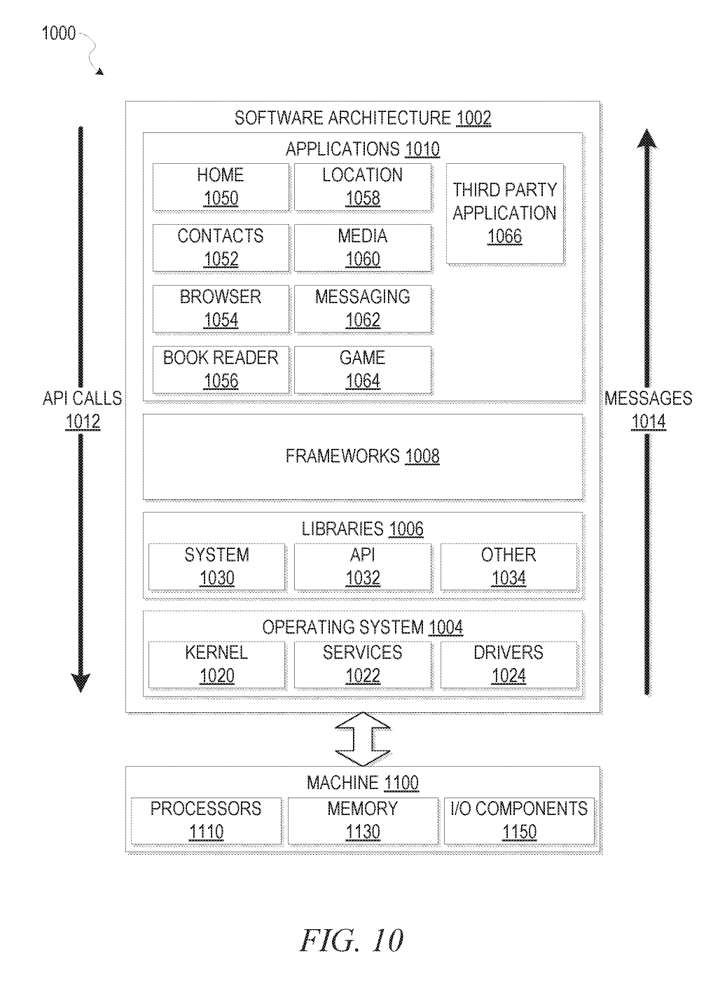

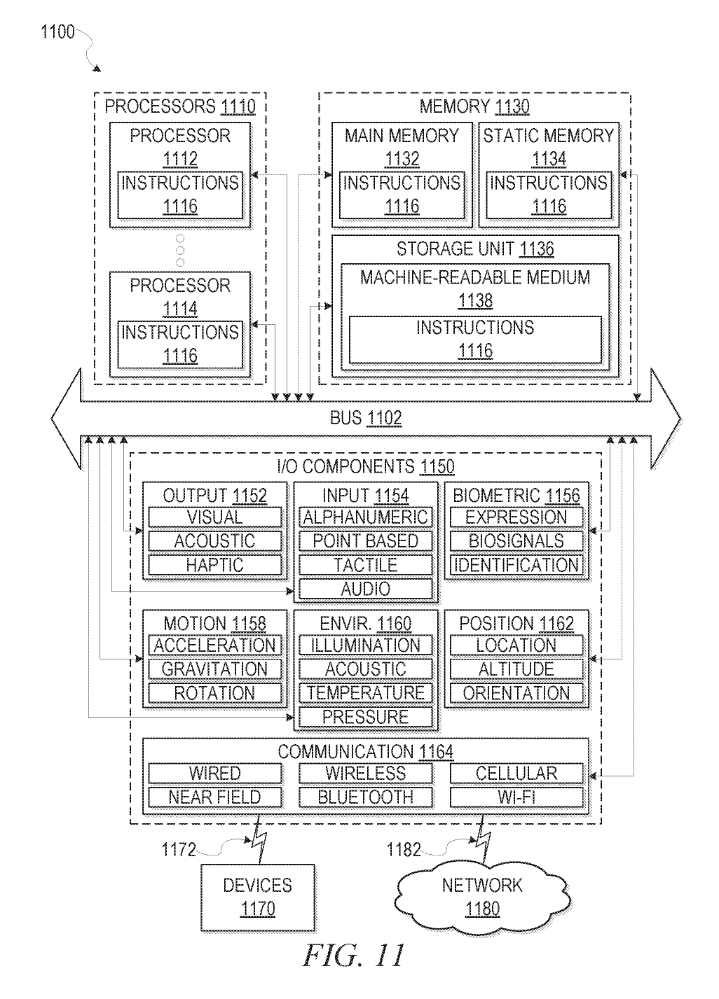

FIG. 1 is a network diagram illustrating a network environment 100 suitable for identifying items depicted in images, according to sonic example embodiments. The network environment 00 includes e-commerce servers 120 and 140, an identification server 130, and devices 150A, 150B, and 150C, all communicatively coupled to each other via a network 170. The devices 150A, 150B, and 150C may be collectively referred to as “devices 150, ” or generically referred to as a “device 150. ” The e-commerce servers 120 and 140 and the identification server 130 may be part of a network-based system 110. Alternatively, the devices 150 may connect to the identification server 130 directly or over a local network distinct from the network 170 used to connect to the e-commerce server 120 or 140. The e-commerce servers 120 and 140, the identification server 130, and the devices 150 may each be implemented in a computer system, in whole or in part, as described below with respect to FIGS. 10-11.

The e-commerce servers 120 and 140 provide an electronic commerce application to other machines (e.g., the devices 150 ) via the network 170. The e-commerce servers 120 and 140 may also be connected directly to, or integrated with, the identification server 130. In some example embodiments, one e-commerce server 120 and the identification server 130 are part of a network-based system 110, while other e-commerce servers the e-commerce server 140 ) are separate from the network-based system 110. The electronic commerce application may provide a way for users to buy and sell items directly to each other, to buy from and sell to the electronic commerce application provider, or both.

Also shown in FIG. 1 is a user 160. The user 160 may be a human user (e.g., a human being), a machine user (e.g., a computer configured by a software program to interact with the devices 150 and the identification server 130 ), or any suitable combination thereof (e.g., a human assisted by a machine or a machine supervised by a human). The user 160 is not part of the network environment 100, but is associated with the devices 150 and may be a user of the devices 150. For example, the device 150 may be a sensor, a desktop computer, a vehicle computer, a tablet computer, a navigational device, a portable media device, or a smart phone belonging to the user 160.

In some example embodiments, the identification server 130 receives data regarding an item of interest to a user. For example, a camera attached to the device 150A can take an image of an item the user 160 wishes to sell and transmit the image over the network 170 to the identification server 130. The identification server 130 identifies the item based on the image. Information for the identified item can be sent to e-commerce server 120 or 140, to the device 150A, or any combination thereof. The information can be used by the e-commerce server 120 or 140 to aid in generating a listing of the item for sale. Similarly, the image may be of an item of interest to the user 160, and the information can be used by the e-commerce server 120 or 140 to aid in selecting listings of items to show to the user 160.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIGS. 10-11. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 170 may be any network that enables communication between or among machines, databases, and devices (e.g., the identification server 130 and the devices 150 ). Accordingly, the network 170 may be a wired network, a wireless network (e.g., a mobile or cellular network), or any suitable combination thereof. The network 170 may include one or more portions that constitute a private network, a public network (e.g., the Internet), or any suitable combination thereof.

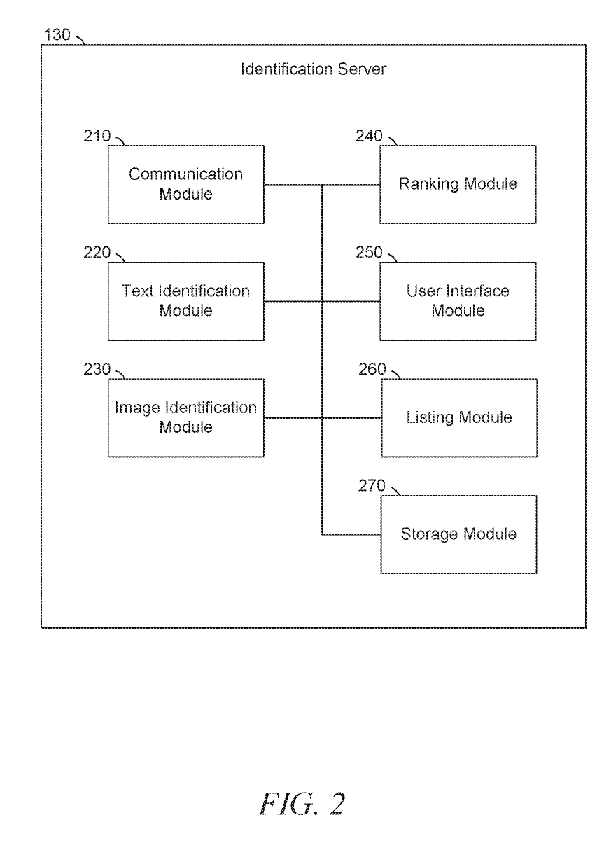

FIG. 2 is a block diagram illustrating components of the identification server 130, according to some example embodiments. The identification server 130 is shown as including a communication module 210, a text identification module 220, an image identification module 230, a ranking module 240, a user interface (UI) module 250, a listing module 260, and a storage module 270 all configured to communicate with each other (e.g., via a bus, shared memory, or a switch). Any one or more of the modules described herein may be implemented using hardware (e.g., a processor of a machine). Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 is configured to send and receive data. For example, the communication module 210 may receive image data over the network 170 and send the received data to the text identification module 220 and the image identification module 230. As another example, the ranking module 240 may determine a best match for a depicted item, and an identifier for the item may be transmitted by the communication module 210 over the network 170 to the e-commerce server 120. The image data may be a two-dimensional image, a frame from a continuous video stream, a three-dimensional image, a depth image, an infrared image, a binocular image, or any suitable combination thereof.

The text identification module 220 is configured to generate a set of proposed matches for an item depicted in an input image, based on text extracted from the input image. For example, text extracted from the input image can be matched against text in a database and the top n (e.g., top 5) matches reported as proposed matches for the item.

The image identification module 230 is configured to generate a set of proposed matches for an item depicted in an input image, using image matching techniques. For example, a CNN trained to distinguish between different media items may be used to report a probability of a match between the depicted item and one or more of the media items. For the purposes of such a CNN, a media item is an item of media capable of being depicted. For example, books, CDs, and DVDs are all media items. Purely electronic media, such as MP4 audio files, are also “media items” in this sense, if they are associated with images. For example, an electronic download version of a CD may be associated with an image of the cover of the CD modified to include a marker that indicates that the version is an electronic download. Accordingly, a trained CNN of the image identification module 230 can identify a probability of a particular image matching the downloadable version of the CD separate from a probability of the particular image matching the physical version of the CD.

The ranking module 240 is configured to combine the set of proposed matches for an item generated by the text identification module 220 with the set of proposed matches for the item generated by the image identification module 230 and rank the combined set. For example, the text identification module 220 and image identification module 230 may each provide a score for each proposed match and the ranking module 240 may combine them by using a weighting factor. The ranking module 240 can report the highest-ranked proposed match as the identified item depicted in the image. The weights used by the ranking module 240 may be determined using an ordinal regression support vector machine (OR-SVM)

The user interface module 250 is configured to cause a user interface to be presented on one or more of the user devices 150A-150C. For example, the user interface module 250 may be implemented by a web server providing hypertext markup language (HTML) files to a user device 150 via the network 170. The user interface may present the image received by the communication module 210, data retrieved from the storage module 270 regarding an item identified in the image by the ranking module 240, an item listing generated or selected by the listing module 260, or any suitable combination thereof.

The listing module 260 is configured to generate an item listing for an item identified using the ranking module. For example, after a user has uploaded an image depicting an item and the item is successfully identified, the listing module 260 may create an item listing including an image of the item from an item catalog, a title of the item from the item catalog, a description from the item catalog, or any suitable combination thereof. The user may be prompted to confirm or modify the generated listing, or the generated listing may be published automatically in response to the identification of the depicted item. The listing may be sent to the e-commerce server 120 or 140 via the communication module 210. In some example embodiments, the listing module 260 is implemented in the e-commerce server 120 or 140 and the listing is generated in response to an identifier for the item being sent from the identification server 130 to the e-commerce server 120 or 140.

The storage module 270 is configured to store and retrieve data generated and used by the text identification module 220, the image identification module 230, the ranking module 240, the user interface module 250, and the listing module 260. For example, the classifier used by the image identification module 230 can be stored by the storage module 270. Information regarding identification of an item depicted in an image, generated by the ranking module 240, can also be stored by the storage module 270. The e-commerce server 120 or 140 can request identification of an item in image (e.g., by providing the image, an image identifier, or both), which can be retrieved from storage by the storage module 270 and sent over the network 170 using the communication module 210.

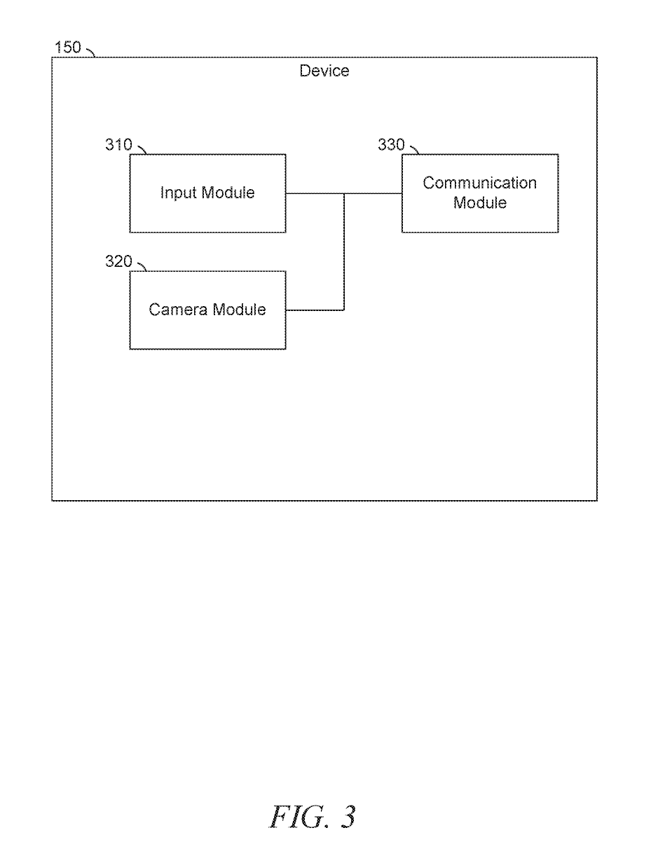

FIG. 3 is a block diagram illustrating components of the device 150, according to some example embodiments. The device 150 is shown as including an input module 310, a camera module 320, and a communication module 330, all configured to communicate with each other (e.g., via a bus, shared memory, or a switch). Any one or more of the modules described herein may be implemented using hardware (e.g., a processor of a machine). Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The input module 310 is configured to receive input from a user via a user interface. For example, the user may enter his or her username and password into the input module, configure a camera, select an image to use as a basis for a listing or an item search, or any suitable combination thereof.

The camera module 320 is configured to capture image data. For example, an image may be received from a camera, a depth image may be received from an infrared camera, a pair of images may be received from a binocular camera, and so on.

The communication module 330 is configured to communicate data received by the input module 310 or the camera module 320 to the identification server 130, the e-commerce server 120, or the e-commerce server 140. For example, the input module 310 may receive a selection of an image taken with the camera module 320 and an indication that the image depicts an item the user (e.g., user 160 ) wishes to sell. The communication module 330 may transmit the image and the indication to the e-commerce server 120. The e-commerce server 120 may send the image to the identification server 130 to request identification of an item depicted in the image, generate a listing template based on the category, and cause the listing template to be presented to the user via the communication module 330 and the input module 310.

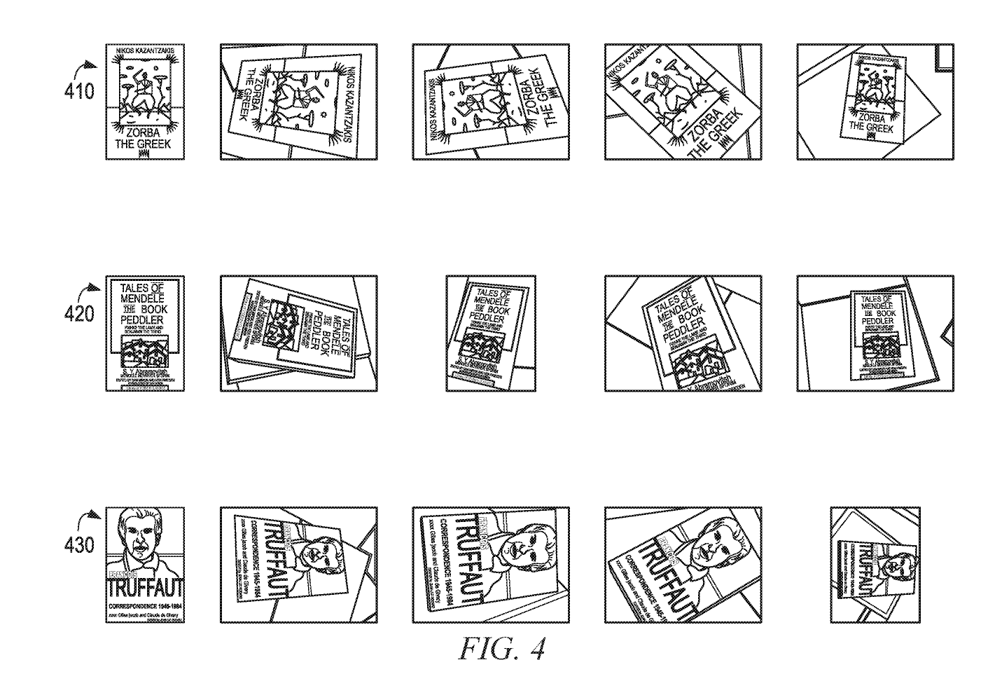

FIG. 4 illustrates reference and non-cooperative images of items, according to some example embodiments. The first entry in each of groups 410, 420, and 430 is a catalog image. The items depicted in the catalog images are well-lit, directly face the camera, and are properly oriented. The remaining images of each group are images taken by users from a variety of orientations and facings. Additionally, the non-catalog images depict background clutter.

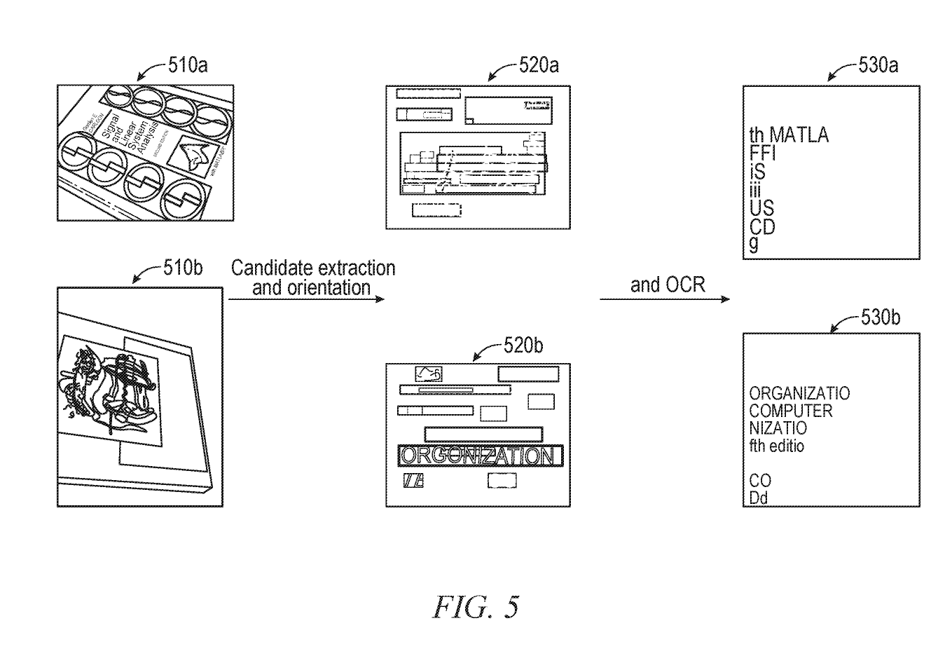

FIG. 5 illustrates operations of text extraction for identifying items depicted in images, according to some example embodiments. Each row in FIG. 5 shows the example operations performed on an input image. Elements 510a and 510b show the input image for each row. Elements 520a and 520b show the results of candidate extraction and orientation. That is, given a query image, blocks of text are identified and oriented using a radon-transform based heuristic. Roughly co-linear characters are identified as lines and fed through OCR (e.g., Tesseract OCR) to obtain text output. Elements 530a and 530b show a subset of the obtained text output, as examples.

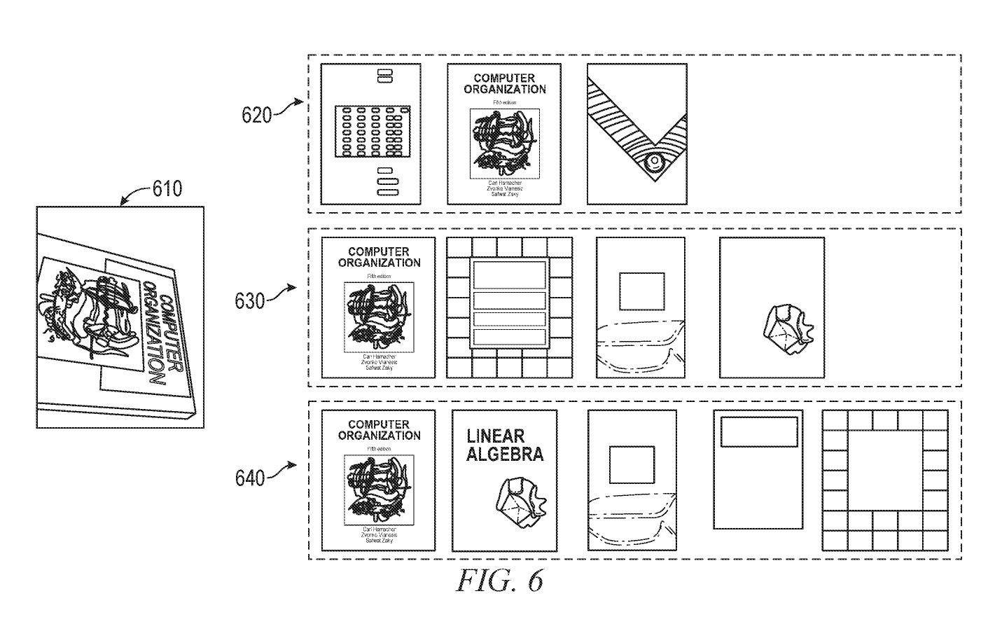

FIG. 6 illustrates an input image depicting a media item and sets of proposed matches for the item, according to sonic example embodiments. Image 610 is an input image. The image 610 is oriented so that the text on the depicted media item is aligned with the image, but the media item is at an angle with respect to the camera. Furthermore, the media item is reflecting a light source, which obscures some of the text depicted in the image. The set of proposed matches 620 depicts the top five matches as reported by the text identification module 220. The set of proposed matches 630 depicts the top five matches as reported by the image identification module 230. The set of proposed matches 640 depicts the top five matches as reported by the ranking module 240. Accordingly, the first entry in the set of proposed matches 640 is correctly reported by the identification server 130 as the match for the input image 610.

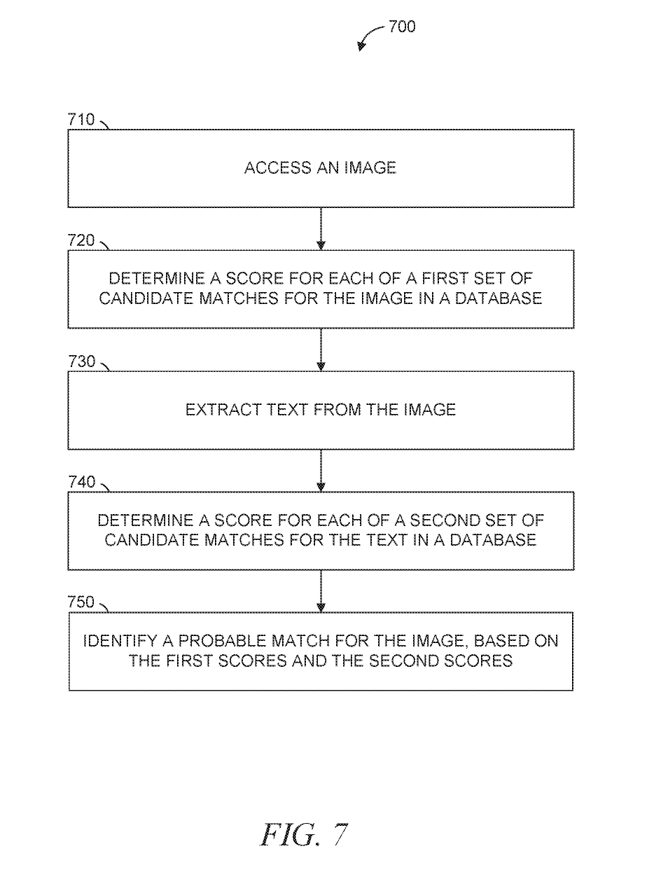

FIG. 7 is a flowchart illustrating operations of an identification server 130 in performing a process of identifying an item in an image, according to some example embodiments. The process 700 includes operations 710, 720, 730, 740, and 750. By way of example only and not limitation, the operations 710-750 are described as being performed by the modules 210-270.

In operation 710, the image classification module 230 accesses an image. For example, the image may be captured by a device 150, sent over the network 170 to the identification server 130, received by the communication module 210 of the identification server 130, and passed to the image classification module 230 by the communication module 210. The image classification module 230 determines a score for each of a first set of candidate matches for the image in a database (operation 720 ). For example, a vector of locally aggregated descriptors (VLAD) may be used to identify candidate matches in a database and rank them. In some example embodiments, the VLAD is constructed by densely extracting speeded up robust feature (SURF) descriptors from a training set and clustering the descriptors using k-means with k=256 to generate the vocabulary. In some example embodiments, the similarity metric is based on the L2 (Euclidian) distance between normalized VLAD descriptors.

In operation 730, the text identification module 220 accesses the image and extracts text from it. The text identification module 220 determines a score for each of a second set of candidate matches for the text in the database. For example, the bag of words (BoW) algorithm may be used to identify candidate matches in the database and rank them. Text may be extracted in an orientation-agnostic manner from the image. The extracted text is reoriented to horizontal alignment via projection analysis. A radon transform is computed and the angle of the line having the least projected area selected. Individual lines of text are extracted using clustering of proximal characters. Maximally stable extremal regions (MSERs) are identified as potential characters within each cluster. Character candidates are grouped into lines by combining regions of similar height if they are adjacent or if their bases have a close y value. Unrealistic line candidates are ruled out if the aspect ratio exceeds a threshold (e.g., if the length of the line is more than 15 times the width).

Identified lines of text are fed through an OCR engine to extract the text. To account for the possibility that the extracted lines of text may be upside-down, the identified lines of text are also rotated by 180 degrees and the rotated lines fed through the OCR engine.

In operation 740, character N-grams are used for text matching. A sliding window of size N is run across each word with sufficient length and non-alphabetic characters are discarded. As an example with N=3, the phrase “I like turtles” would be broken down into “lik,” “ike,” “tur,” “urt,” “rtl” “tle,” and “les.” In some example embodiments, case is ignored by converting all characters to lowercase.

The un-normalized histogram of N-grains for each document is referred to as f. In some example embodiments, the following scheme is used to compute a normalized similarity score between query and document:

| Query | Document |
|---|---|
| N₂(N₁(\vec{f})^{T}\vec{γ}) | N₂(N₂(\vec{f})^{T}\vec{γ}) |

where N₁ and N₂ are functions for computing L1 and L2 normalization, respectively. The gamma vector is the vector of inverse document frequency (idf) weights. For each unique N-gram g, the corresponding idf weight is computed as

$$γ ( g ) = ln \frac{\vert D \vert}{\vert d ∈ D \text{:} g ∈ d \vert} \text{:}$$

the natural log of the number of documents in the database divided by the number of documents containing the N-gram g. The final normalization is an L2 normalization.

In operation 750, the ranking module 240 identifies a probable match for the image, based on the first set of scores and the second set of scores. For example, the corresponding scores may be summed, weighted, or otherwise combined, and the candidate match having the highest resulting score identified as the probable match.

The vector Φ(x, y)=[S₁(x, y)Sₛ(x, y) . . . S_{M}(x, y)]^{T} combines a set of similarity measures into a combined ranking. Each S(x, y) represents a similarity measure from one feature type. The optimal weighting of the terms for calculating Φ always provides a higher similarity between a correct query/reference match than an incorrect one. Accordingly, the optimization below may be undertaken during the training process to learn an optimal weighting vector w:

$${argmin}_{\vec{w}} \frac{1}{2} {\vec{w}}^{T} \vec{w} + C \sum {ξ}_{i , j}$$

$$s . t . {\vec{w}}^{T} ( Φ ( {x}_{i} , {y}_{i} ) - Φ ( {x}_{i} , {y}_{i} ) ) > 1 - {ξ}_{i , j} ∀ i , j \neq i$$

$${ξ}_{i , j} \geq 0 ∀ i , j$$

During operation 750, the individual S values (e.g., one for the OCR match and one for the VLAD match) are combined into a (Φ ) vector, and the combined score generated by multiplying w by Φ. In some example embodiments, the item having the highest combined score for the query image is taken as the matching item. In some example embodiments, when no items have a combined score that exceed a threshold, no items are found to be matches. In some example embodiments, the set of items having combined scores that exceed a threshold, the set of K items having the highest combined scores, or a suitable combination thereof are selected for further image matching using geometric features, as described below.

The potential matches and the query image are resized to a standard size (e.g., 256×256 pixels). Histograms of oriented gradients (HOG) values are determined for 8 orientations, 8 by 8 pixels per cell, and 2 by 2 cells per block for each resized image. For each potential match, a linear transformation matrix is found that minimizes the error between the transformed query matrix and the potentially matching image. The minimized errors are compared, and the potential match having the lowest minimized error is reported as a match.

One method of identifying the linear transformation matrix that minimizes the error is to randomly generate a number (e.g., 100 ) of such transformation matrices and to determine the error for each of those matrices. If the lowest error is below a threshold, the corresponding matrix is used. Otherwise, a new set of random transformation matrices is generated and evaluated. After a predetermined number of iterations, the matrix corresponding to the lowest error found is used, and the method terminated.

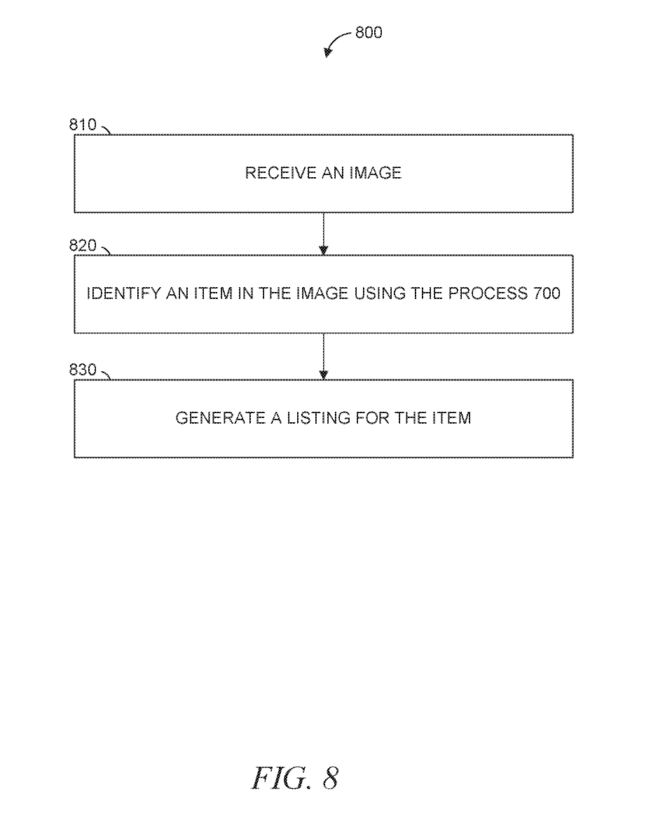

FIG. 8 is a flowchart illustrating operations of a server in performing a process 800 of automatically generating a for-sale listing of an item depicted in an image, according to some example embodiments. The process 800 includes operations 810, 820, and 830. By way of example only and not limitation, the operations 810-830 are described as being performed by the identification server 130 and the e-commerce server 120.

In operation 810, the e-commerce server 120 receives an image. For example, a user 160 may take an image using a device 150 and upload it to the e-commerce server 120. In operation 820, the identification server 120 identifies an item depicted in the image using the process 700. For example, the e-commerce server 130 may forward the image to the identification server 120 for identification. In some example embodiments, the e-commerce server 120 and the identification server 130 are integrated and the e-commerce server 120 identifies the item in the image.

In operation 830, the e-commerce server 120 generates a listing describing the item as being for sale by the user 160. For example, if the user uploaded a picture of a book entitled “The Last Mogul,” a listing for “The Last Mogul” may be generated. In some example embodiments, the generated listing includes a catalog image of the item, the title of the item, and a description of the item, all loaded from a product database. The user may be presented a user interface to select additional listing options or default listing options (e.g., price or initial price, sales formation or fixed-price, or shipping options) may be used.

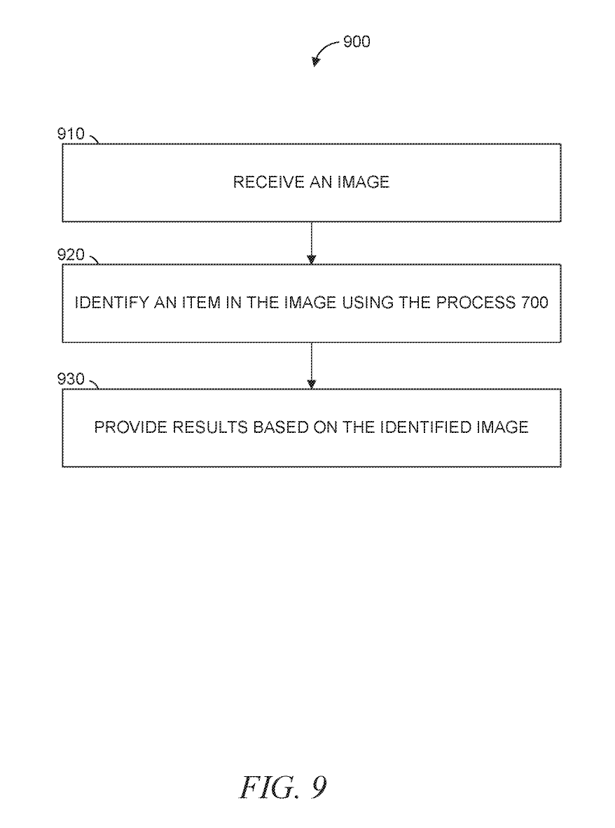

FIG. 9 is a flowchart illustrating operations of a server in performing a process 900 of providing results based on an item depicted in an image, according to some example embodiments. The process 900 includes operations 910, 920, and 930. By way of example only and not limitation, the operations 910-930 are described as being performed by the identification server 130 and the e-commerce server 120.

In operation 910, the e-commerce server 120 or a search engine sever receives an image. For example, a user 160 may take an image using a device 150 and upload it to the e-commerce server 120 or the search engine server. In operation 920, the identification server 130 identifies an item depicted in the image using the process 700. For example, the e-commerce server 120 may forward the image to the identification server 130 for identification. In some example embodiments, the e-commerce server 130 and the identification server 120 are integrated and the e-commerce server 130 identifies the item depicted in the image. Similarly, a search engine server (e.g., a server to locate documents, web pages, images, videos, or other files) may receive the image and, via the identification server 130, identify a media item depicted in the image.

In operation 930, the e-commerce server 120 or the search engine server provides information regarding one or more items to the user in response to the receipt of the image. The items are selected based on the identified item depicted in the image. For example, if the user uploaded a picture of a book entitled “The Last Mogul,” sales listings for “The Last Mogul” listed through the e-commerce server 120 or 140 may be identified and provided to the user that provided the image (e.g., transmitted over the network 170 to the device 150A for display to the user 160). As another example, if the user uploaded the picture of “The Last Mogul” to a general search engine, web pages mentioning “The Last Mogul” may be identified, stores having “The Last Mogul” for sale may be identified, videos of reviews for “The Last Mogul” may be identified, and one or more of these may be provided to the user (e.g., in a web page for display on a web browser of the user's device).

According to various example embodiments, one or more of the methodologies described herein may facilitate identifying items (e.g., media items) depicted in images. Moreover, one or more of the methodologies described herein may facilitate identifying items depicted in images relative to image classification methods or text classification methods alone. Furthermore, one or more of the methodologies described herein may facilitate identifying items depicted in images more quickly and with a lower use of computational power compared to previous methods.

When these effects are considered in aggregate, one or more of the methodologies described herein may obviate a need for certain efforts or resources that otherwise would be involved in identifying items depicted in images. Efforts expended by a user in ordering items of interest may also be reduced by one or more of the methodologies described herein. For example, accurately identifying an item of interest for a user from an image may reduce the amount of time or effort expended by the user in creating an item listing or finding an item to purchase. Computing resources used by one or more machines, databases, or devices (e.g., within the network environment 100 ) may similarly be reduced. Examples of such computing resources include processor cycles, network traffic, memory usage, data storage capacity, power consumption, and cooling capacity.

### SOFTWARE ARCHITECTURE

FIG. 10 is a block diagram 1000 illustrating an architecture of software 1002, which may be installed on any one or more of the devices described above. FIG. 10 is merely a non-limiting example of a software architecture, and it will be appreciated that many other architectures may be implemented to facilitate the functionality described herein. The software 1002 may be implemented by hardware such as machine 1100 of FIG. 11 that includes processors 1110, memory 1130, and input/output (I/O) components 1150. In this example architecture, the software 1002 may be conceptualized as a stack of layers where each layer may provide a particular functionality. For example, the software 1002 includes layers such as an operating system 1004, libraries 1006, frameworks 1008, and applications 1010. Operationally, the applications 1010 invoke application programming interface (API) calls 1012 through the software stack and receive messages 1014 in response to the API calls 1012, according to some implementations.

In various implementations, the operating system 1004 manages hardware resources and provides common services. The operating system 1004 includes, for example, a kernel 1020, services 1022, and drivers 1024. The kernel 1020 acts as an abstraction layer between the hardware and the other software layers in some implementations. For example, the kernel 1020 provides memory management, processor management (e.g., scheduling), component management, networking, security settings, among other functionality. The services 1022 may provide other common services for the other software layers. The drivers 1024 may be responsible for controlling or interfacing with the underlying hardware. For instance, the drivers 1024 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

In some implementations, the libraries 1006 provide a low-level common infrastructure that may be utilized by the applications 1010. The libraries 1006 may include system libraries 1030 (e.g., C standard library) that may provide functions such as memory allocation functions, string manipulation functions, mathematic functions, and the like. In addition, the libraries 1006 may include API libraries 1032 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3 ), Advanced Audio Coding (AAC), Adaptive Multi-Rate (AMR) audio codec, Joint Photographic Experts Group (JPEG or JPG), Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1006 may also include a wide variety of other libraries 1034 to provide many other APIs to the applications 1010.

The frameworks 1008 provide a high-level common infrastructure that may be utilized by the applications 1010, according to some implementations. For example, the frameworks 1008 provide various graphic user interface (GUI) functions, high-level resource management, high-level location services, and so forth. The frameworks 1008 may provide a broad spectrum of other APIs that may be utilized by the applications 1010, some of which may be specific to a particular operating system or platform.

In an example embodiment, the applications 1010 include a home application 1050, a contacts application 1052, a browser application 1054, a book reader application 1056, a location application 1058, a media application 1060, a messaging application 1062, a game application 1064, and a broad assortment of other applications such as third party application 1066. According to some embodiments, the applications 1010 are programs that execute functions defined in the programs. Various programming languages may be employed to create one or more of the applications 1010, structured in a variety of manners, such as object-orientated programming languages (e.g., Objective-C, Java, or C++) or procedural programming languages (e.g., C or assembly language). In a specific example, the third party application 1066 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 1066 may invoke the API calls 1012 provided by the mobile operating system 1004 to facilitate functionality described herein.

### EXAMPLE MACHINE ARCHITECTURE AND MACHINE-READABLE MEDIUM

FIG. 11 is a block diagram illustrating components of a machine 1100, according to some example embodiments, able to read instructions from a machine-readable medium (e,g., a machine-readable storage medium) and perform any one or more of the methodologies discussed herein. Specifically, FIG. 11 shows a diagrammatic representation of the machine 1100 in the example form of a computer system, within which instructions 1116 (e.g., software, a program, an application, an applet, app, or other executable code) for causing the machine 1100 to perform any one or more of the methodologies discussed herein may be executed. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1116, sequentially or otherwise, that specify actions to be taken by machine 1100. Further, while only a single machine 1100 is illustrated, the term “machine” shall also be taken to include a collection of machines 1100 that individually or jointly execute the instructions 1116 to perform any one or more of the methodologies discussed herein. As a practical matter, certain embodiments of the machine 1100 may be more suitable to the methodologies described herein. For example, while any computing device with sufficient processing power may serve as the identification server 130, accelerometers, cameras, and cellular network connectivity are not directly related to the ability of the identification server 130 to perform the image identification methods discussed herein. Accordingly, in some example embodiments, cost savings are realized by implementing the various described methodologies on machines 1100 that exclude additional features unnecessary to the performance of the tasks assigned to each machine 1100 (e.g., by implementing the identification server 130 in a server machine without a directly connected display and without integrated sensors commonly found only on wearable or portable devices).

The machine 1100 may include processors 1110, memory 1130, and I/O components 1150, which may be configured to communicate with each other via a bus 1102. In an example embodiment, the processors 1110 (e.g., a Central Processing Unit (CPU), a Reduced Instruction Set Computing (RISC) processor, a Complex instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1112 and processor 1114 that may execute instructions 1116. The term “processor” is intended to include multi-core processors that may comprise two or more independent processors (also referred to as “cores”) that may execute instructions contemporaneously. Although FIG. 11 shows multiple processors, the machine 1100 may include a single processor with a single core, a single processor with multiple cores a multi-core process), multiple processors with a single core, multiple processors with multiples cores, or any combination thereof.

The memory 1130 may include a main memory 1132, a static memory 1134, and a storage unit 1136 accessible to the processors 1110 via the bus 1102. The storage unit 1136 may include a machine-readable medium 1138 on which is stored the instructions 1116 embodying any one or more of the methodologies or functions described herein. The instructions 1116 may also reside, completely or at least partially, within the main memory 1132, within the static memory 1134, within at least one of the processors 1110 (e.g., within the processor's cache memory), or any suitable combination thereof, during execution thereof by the machine 1100. Accordingly, in various implementations, the main memory 1132, static memory 1134, and the processors 1110 are considered as machine-readable media 1138.

As used herein, the term “memory” refers to a machine-readable medium 1138 able to store data temporarily or permanently and may be taken to include, but not be limited to, random-access memory (RAM), read-only memory (ROM), buffer memory, flash memory, and cache memory. While the machine-readable medium 1138 is shown in an example embodiment to be a single medium, the term “machine-readable medium” should be taken to include a single medium or multiple media (e.g., a centralized or distributed database, or associated caches and servers) able to store instructions 1116. The term “machine-readable medium” shall also be taken to include any medium, or combination of multiple media, that is capable of storing instructions (e.g., instructions 1116 ) for execution by a machine (e.g., machine 1100 ), such that the instructions, when executed by one or more processors of the machine 1100 (e.g., processors 1110 ), cause the machine 1100 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “machine-readable medium” specifically excludes non-statutory signals per se.

The I/O components 1150 include a wide variety of components to receive input, provide output, produce output, transmit information, exchange information, capture measurements, and so on. In general, it will be appreciated that the I/O components 1150 may include many other components that are not shown in FIG. 11. The I/O components 1150 are grouped according to functionality merely for simplifying the following discussion and the grouping is in no way limiting. In various example embodiments, the I/O components 1150 include output components 1152 and input components 1154. The output components 1152 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 1154 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instrument), tactile input components (e.g., a physical button, a touch screen that provides location and force of touches or touch gestures, or other tactile input components), audio input components (e.g., a microphone), and the like.

In some further example embodiments, the I/O components 1150 include biometric components 1156, motion components 1158, environmental components 1160, or position components 1162, among a wide array of other components. For example, the biometric components 1156 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1158 include acceleration sensor components (e.g., accelerometer), gravitation sensor components, rotation sensor components (e.g., gyroscope), and so forth. The environmental components 1160 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 1162 include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via coupling 1182 and coupling 1172, respectively. For example, the communication components 1164 include a network interface component or another suitable device to interface with the network 1180. In further examples, communication components 1164 include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., a peripheral device coupled via a USB).

Moreover, in some implementations, the communication components 1164 detect identifiers or include components operable to detect identifiers. For example, the communication components 1164 include Radio Frequency Identification (RFID) tag reader components, NFC smart tag detection components, optical reader components (e.g., an optical sensor to detect a one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, Uniform Commercial Code Reduced Space Symbology (UCC RSS)-2D bar code, and other optical codes), acoustic detection components (e.g., microphones to identify tagged audio signals), or any suitable combination thereof. In addition, a variety of information can be derived via the communication components 1164, such as, location via Internet Protocol (IP) geo-location, location via Wi-Fi® signal triangulation, location via detecting a NFC beacon signal that may indicate a particular location, and so forth.

### TRANSMISSION MEDIUM

In various example embodiments, one or more portions of the network 1180 may he an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1180 or a portion of the network 1180 may include a wireless or cellular network and the coupling 1182 may be a Code Division Multiple Access (CDMA) connection, a Global System for Mobile communications (GSM) connection, or other type of cellular or wireless coupling. In this example, the coupling 1182 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

In example embodiments, the instructions 1116 are transmitted or received over the network 1180 using a transmission medium via a network interface device (e,g, a network interface component included in the communication components 1164) and utilizing any one of a number of well-known transfer protocols (e.g., Hypertext Transfer Protocol (HTTP)). Similarly, in other example embodiments, the instructions 1116 are transmitted or received using a transmission medium via the coupling 1172 (e.g., a peer-to-peer coupling) to devices 1170. The term “transmission medium” shall be taken to include any intangible medium that is capable of storing, encoding, or carrying instructions 1116 for execution by the machine 1100, and includes digital or analog communications signals or other intangible medium to facilitate communication of such software.

### LANGUAGE

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the tenn “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly. structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system comprising:
a memory having instructions embodied thereon; and
one or more processors configured by the instructions to perform operations comprising:
storing a plurality of records for a plurality of corresponding items, each record of the plurality of records including text data and image data for the item corresponding to the record;
accessing a first image depicting a first item;
generating a first set of candidate matches for the first item from the plurality of items based on the first image and the image data of the plurality of records;
recognizing text in the first image;
generating a second set of candidate matches for the first item from the plurality of items based on the recognized text and the text data of the plurality of records;
combining the first set of candidate matches and the second set of candidate matches into a combined set of candidate matches; and
identifying a top-ranked candidate match of the combined set of candidate matches.

2. The system of claim 1, wherein:
the first image is associated with a user account; and
the operations further comprise generating a listing in an electronic marketplace, the listing being associated with the user account, the listing being for the top-ranked candidate match.

3. The system of claim 1, wherein:
the recognizing of the text includes extracting clusters of text in an orientation-agnostic manner; and
the generating of the second set of candidate matches includes matching character N-grams of fixed size N in the clusters of text.

4. The system of claim 3, wherein the fixed size N is 3.

5. The system of claim 1, wherein:
the generating of the first set of candidate matches includes generating a first score corresponding to each candidate match in the first set of candidate matches;
the generating of the second set of candidate matches includes generating a second score corresponding to each candidate match in the second set of candidate matches;
the combining of the first set of candidate matches and the second set of candidate matches into the combined set of candidate matches includes, for each candidate match included in both the first set of candidate matches and the second set of candidate matches, summing the first score and the second score corresponding to the candidate match; and
the identifying of the top-ranked candidate match of the combined set of candidate matches identifies a candidate match in the combined set of candidate matches having a highest summed score.

6. The system of claim 1, wherein the operations further comprise:
receiving the first image from a client device as part of a search request;
identifying a set of results based on the top-ranked candidate match; and
responsive to the search request, providing the set of results to the client device.

7. The system of claim 6, wherein:
the set of results comprise a set of item listings of items for sale.

8. method comprising:
storing a plurality of records for a plurality of corresponding items, each record of the plurality of records including text data and image data for the item corresponding to the record;
accessing a first image depicting a first item;
generating a first set of candidate matches for the first item from the plurality of items based on the first image and the image data of the plurality of records;
recognizing text in the first image;
generating, by a processor of a machine, a second set of candidate matches for the first item from the plurality of items based on the recognized text and the text data of the plurality of records;
combining the first set of candidate matches and the second set of candidate matches into a combined set of candidate matches; and
identifying a top-ranked candidate match of the combined set of candidate matches.

9. The method of claim 8, wherein:
the first image is associated with a user account; and
the method further comprises generating a listing in an electronic marketplace associated with the user account, the listing being for the top-ranked candidate match.

10. The method of claim 8, wherein:
the recognizing of the text includes extracting clusters of text in an orientation-agnostic matter; and
the generating of the second set of candidate matches includes matching character N-grains of fixed size N in the clusters of text.

11. The method of claim 10, wherein the fixed size N is 3.

12. The method of claim 8, wherein:
the generating of the first set of candidate matches includes generating a first score corresponding to each candidate match in the first set of candidate matches;
the generating of the second set of candidate matches includes generating a second score corresponding to each candidate match in the second set of candidate matches;
the combining of the first set of candidate matches and the second set of candidate matches into the combined set of candidate matches includes, for each candidate match included in both the first set of candidate matches and the second set of candidate matches, summing the first score and the second score corresponding to the candidate match; and
the identifying of the top-ranked candidate match of the combined set of candidate matches identifies a candidate match in the combined set of candidate matches having a highest summed score.

13. The method of claim 8, further comprising:
receiving the first image from a client device as part of a search request;
identifying a set of results based on the top-ranked candidate match; and
responsive to the search request, providing the set of results to the client device.

14. The method of claim 13, wherein:
the set of results comprises a set of item listings of items for sale.

15. A machine-readable medium having instructions embodied thereon, the instructions executable by one or more processors of a machine to perform operations comprising:
storing a plurality of records for a plurality of corresponding items, each record of the plurality of records including text data and image data for the item corresponding to the record;
accessing a first image depicting a first item;
generating a first set of candidate matches for the first item from the plurality of items based on the first image and the image data of the plurality of records;
recognizing text in the first image;
generating a second set of candidate matches for the first item from the plurality of items based on the recognized text and the text data of the plurality of records;
combining the first set of candidate matches and the second set of candidate matches into a combined set of candidate matches; and
identifying a top-ranked candidate match of the combined set of candidate matches.

16. The machine-readable medium of claim 15, wherein:
the first image is associated with a user account; and
the operations further comprise generating a listing in an electronic marketplace associated with the user account, the listing being for the top-ranked candidate match.

17. The machine-readable medium of claim 15, wherein:
the recognizing of the text includes extracting clusters of text in an orientation-agnostic matter; and
the generating of the second set of candidate matches includes matching character N-grams of fixed size N in the clusters of text.

18. The machine-readable medium of claim 17, wherein the fixed size N is 3.

19. The machine-readable medium of claim 15, wherein:
the generating of the first set of candidate matches includes generating a first score corresponding to each candidate match in the first set of candidate matches;
the generating of the second set of candidate matches includes generating a second score corresponding to each candidate match in the second set of candidate matches;
the combining of the first set of candidate matches and the second set of candidate matches into the combined set of candidate matches includes, for each candidate match included in both the first set of candidate matches and the second set of candidate matches, summing the first score and the second score corresponding to the candidate match; and
the identifying of the top-ranked candidate match of the combined set of candidate matches identifies a candidate match in the combined set of candidate matches having a highest summed score.

20. The machine-readable medium of claim 15, wherein the operations further comprise:
receiving the first image from a client device as part of a search request;
identifying a set of results based on the top-ranked candidate match; and
responsive to the search request, providing the set of results to the client device.
